(19) United States
(12) Patent Application Publication
(10) Pub. No.: US 2020/0103907 A1
(43) Pub. Date: Apr. 2, 2020

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Toshiyuki Kaji, Wako-shi (JP); Katsuya Yashiro, Wako-shi (JP); Toru Kokaki, Wako-shi (JP); Masanori Takeda, Wako-shi (JP); Hiroshi Oguro, Wako-shi (JP)

(21) Appl. No.: 16/495,871

(22) PCT Filed: Mar. 30, 2017
(86) PCT No.: PCT/JP2017/013373

§ 371 Date: Sep. 20, 2019

(51) Int. Cl. G05D 1/02; G08G 1/16

(52) U.S. Cl. CPC G05D 1/0214; G05D 2201/0213; G08G 1/16

(57) ABSTRACT

A vehicle control system includes: a recognizer configured to recognize an obstacle in a moving direction of a vehicle; an estimator configured to estimate at least one of a kind and a shape of the obstacle recognized by the recognizer; and an action plan generator configured to generate an action plan of the vehicle based on an estimation result of the estimator.

### TECHNICAL FIELD

The present invention relates to a vehicle control system, a vehicle control method, and a vehicle control program.

### BACKGROUND ART

In recent years, research of automated driving of vehicles has been in progress. With regard to the research, a technology for calculating a distance between a vehicle and an obstacle object for the vehicle to avoid the obstacle object and change a lane to an adjacent lane based on turning features of the vehicle and a lane width of the lane, specifying a stop position at which the vehicle stops before the vehicle changes the lane based on the calculated distance, and outputting a guidance related to the specified stop position when there is an obstacle object in front of the vehicle has been proposed (for example, see Patent Literature 1).

### CITATION LIST

### Patent Literature

### [Patent Literature 1]

Japanese Unexamined Patent Application, First Publication No. 2011-98614

### SUMMARY OF INVENTION

### Technical Problem

In the method of the technology in the related art, however, since a vehicle stops before the vehicle arrives at an obstacle object and performs lane change to avoid the obstacle object subsequently regardless of a kind or the like of obstacle object, an inappropriate guidance is performed. As a result, there is a possibility of congestion or the like being caused.

The present invention is devised in view of such circumstances and an object of the present invention to provide a vehicle control system, a vehicle control method, and a vehicle control program capable of realizing traveling through appropriate automated driving in accordance with a kind or shape of an obstacle.

### Solution to Problem

According to an aspect, there is provided a vehicle control system including: a recognizer configured to recognize an obstacle in a moving direction of a vehicle; an estimator configured to estimate at least one of a kind and a shape of the obstacle recognized by the recognizer; and an action plan generator configured to generate an action plan of the vehicle based on an estimation result of the estimator.

According to another aspect, in the vehicle control system, the estimator may estimate at least one of the kind and the shape of the obstacle based on a feature amount obtained in a recognition course by the recognizer.

According to another aspect, in the vehicle control system, the action plan generator may generate an action plan to drive over or avoid the obstacle based on the estimation result of the estimator.

According to another aspect, in the vehicle control system, the action plan generator may decelerate the vehicle when the action plan to drive over the obstacle is generated.

According to another aspect, the vehicle control system may further include a passable determiner configured to determine whether the vehicle drives over and passes by the obstacle based on at least one of the kind and the shape of the obstacle estimated by the estimator and information regarding a shape of the vehicle.

According to another aspect, in the vehicle control system, the action plan generator may generate an action plan to perform at least one of a change in a state of the vehicle and control related to steering of the vehicle when the vehicle drives over the obstacle.

According to another aspect, the vehicle control system may further include a buffering device configured to alleviate a shock from a road surface to the vehicle; and a buffering degree controller configured to control the degree of buffering by the buffering device before the vehicle drives over the obstacle or while the vehicle drives over the obstacle.

According to another aspect, the vehicle control system may further include a receptor configured to receive an operation from an occupant of the vehicle. On the basis of setting information which is based on the operation received by the receptor, the action plan generator may change the action plan which is based on the obstacle.

According to another aspect, in the vehicle control system, the passable determiner may determine that the vehicle drives over and passes by the obstacle based on the degree of deformation from a predetermined shape of the obstacle.

According to another aspect, there is provided a vehicle control method including: by an onboard computer, recognizing an obstacle in a moving direction of a vehicle; estimating at least one of a kind and a shape of the recognized obstacle; and generating an action plan of the vehicle based on an estimated result.

According to another aspect, there is provided a non-transitory computer-readable storage medium that stores a vehicle control program causing an onboard computer to perform at least: recognizing an obstacle in a moving direction of a vehicle; estimating at least one of a kind and a shape of the recognized obstacle; and generating an action plan of the vehicle based on an estimated result.

### Advantageous Effects of Invention

According to an aspect, it is possible to realize traveling through appropriate automated driving in accordance with a kind or shape of an obstacle.

According to another aspect, it is possible to estimate at least one of the kind and the shape of an obstacle with high precision by using a feature amount.

According to another aspect, it is possible to alleviate a shock or minimize slipping by the obstacle when the vehicle drives over an obstacle.

According to another aspect, since a change in a lane is not performed for all the obstacles, it is possible to realize traveling through appropriate automated driving. In addition, it is possible to suppress congestion or the like due to an inappropriate lane change.

According to another aspect, when the vehicle drives over an obstacle, it is possible to perform appropriate control on the vehicle.

According to another aspect, it is possible to alleviate a shock to the vehicle when the vehicle drives over an obstacle.

According to another aspect, it is possible to realize automated driving in accordance with an intention of an occupant, for example, when the occupant is anxious about uncleanness or the like of the vehicle and does not want to drive over an obstacle.

### BRIEF DESCRIPTION OF DRAWINGS

FIG. 1 is a diagram illustrating a configuration of a vehicle system including an automated driving controller according to an embodiment.

FIG. 2 is a diagram illustrating an aspect in which an own vehicle position recognizer recognizes a relative position and posture of a vehicle to a traveling lane.

FIG. 3 is a diagram illustrating an aspect in which a target trajectory is generated based on a recommended lane.

FIG. 4 is a diagram illustrating an aspect of an obstacle object in front of the vehicle.

FIG. 5 is a diagram illustrating an example of an estimation table.

FIG. 6 is a diagram illustrating an aspect of passable determination.

FIG. 7 is a diagram illustrating an aspect in which the vehicle drives over an obstacle object to travel.

FIG. 8 is a diagram illustrating an axle suspension type.

FIG. 9 is a diagram illustrating an aspect in which an obstacle object is avoided for traveling.

FIG. 10 is a diagram illustrating an example of a setting screen on which content of automated driving is set.

FIG. 11 is a flowchart illustrating an example of action plan generation according to an embodiment.

### DESCRIPTION OF EMBODIMENTS

Hereinafter, a vehicle control system, a vehicle control method, and a vehicle control program will be described with reference to the drawings. In embodiments, a vehicle control system is assumed to be applied to an automated driving vehicle. The automated driving refers to, for example, automatically controlling at least one of an accelerated or decelerated speed and steering of a vehicle and traveling the vehicle.

### [Overall Configuration]

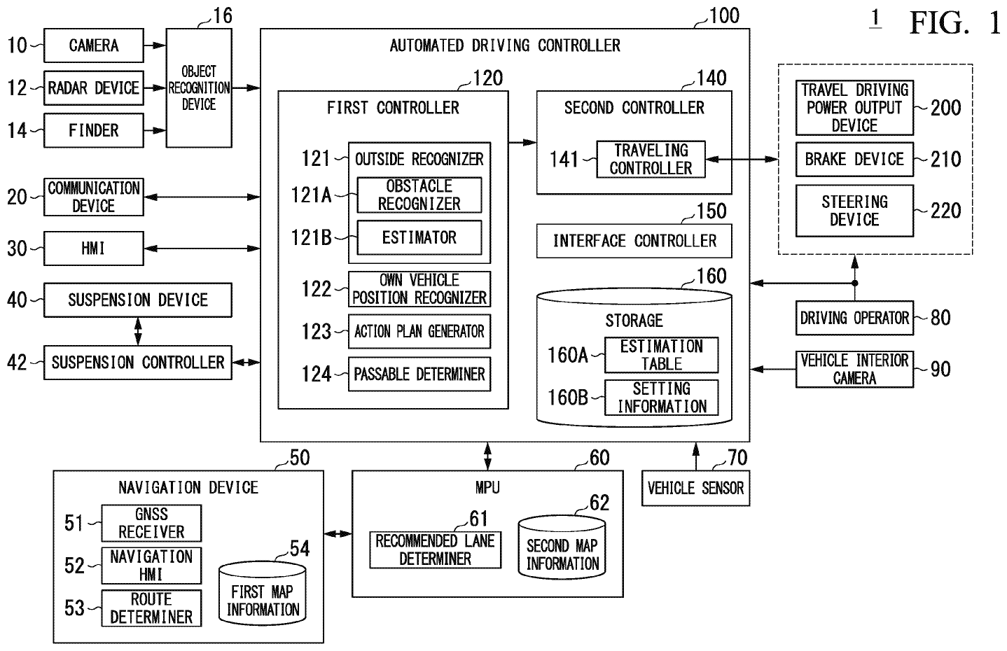

FIG. 1 is a diagram illustrating a configuration of a vehicle system 1 including an automated driving controller 100 according to an embodiment. A vehicle in which the vehicle control system 1 is mounted (hereinafter referred to as a “vehicle M,”) is, for example, a vehicle such as a two-wheeled vehicle, a three-wheeled vehicle, or a four-wheeled vehicle. A driving source of the vehicle includes an internal combustion engine such as a diesel engine or a gasoline engine, an electric motor, and a combination thereof. The electric motor operates using power generated by a power generator connected to the internal combustion engine or power discharged from a secondary cell or a fuel cell.

The vehicle control system 1 includes, for example, a camera (imaging unit) 10, a radar device 12, a finder 14, an object recognition device 16, a communication device 20, a human machine interface (HMI) 30, a suspension device 40, a suspension controller 42, a navigation device 50, a micro processing unit (MPU) 60, a vehicle sensor 70, a driving operator 80, a vehicle interior camera 90, an automated driving controller 100, a travel driving power output device 200, a brake device 210, and a steering device 220. The devices and units are connected to each other via a multiplex communication line such as a controller area network (CAN) communication line, a serial communication line, or a wireless communication network. The configuration illustrated in FIG. 1 is merely exemplary, a part of the configuration may be omitted, and another configuration may be further added. The “vehicle control system” includes the camera 10, the radar device 12, the finder 14, the object recognition device 16, the suspension device 40, the suspension controller 42, and the automated driving controller 100. Either or both of the HMI 30 and an interface controller 150 to be described below is an example of a “receptor.” The suspension device 40 is an example of a “buffering device.” The suspension controller 42 is an example of a “buffering degree controller.”

The camera 10 is, for example, a digital camera that uses a solid-state image sensor such as a charged coupled device (CCD) or a complementary metal oxide semiconductor (CMOS). The single camera 10 or the plurality of cameras 10 are mounted on any portion of the vehicle M. In the case of forward imaging, the camera 10 is mounted on an upper portion of a front windshield, a rear surface of a rearview mirror, or the like. In the case of backward imaging, the camera 10 is mounted on an upper portion of a rear windshield, a backdoor, or the like. In the case of side imaging, the camera 10 is mounted on a door mirror or the like. For example, the camera 10 periodically images the periphery of the vehicle M repeatedly. The camera 10 may be a stereo camera. The camera 10 may be an omnidirectional (360°) camera capable of imaging all the directions in the horizontal direction of the vehicle M.

The radar device 12 radiates radio waves such as millimeter waves to the periphery of the vehicle M and detects radio waves (reflected waves) reflected from an object to detect at least a position (a distance and an azimuth) of the object. The single radar device 12 or the plurality of radar devices 12 are mounted on any portion of the vehicle M. The radar device 12 may detect a position and a speed of an object in conformity with a frequency modulated continuous wave (FM-CW) scheme.

The finder 14 is a light detection and ranging or laser imaging detection and ranging (LIDAR) finder that measures scattered light of radiated light and detects a distance to a target. The single finder 14 or the plurality of finders 14 are mounted on any portion of the vehicle M.

The object recognition device 16 performs a sensor fusion process on detection results from some or all of the camera 10, the radar device 12, and the finder 14 and recognizes a position, a type, a speed, and the like of an object. The object recognition device 16 outputs a recognition result to the automated driving controller 100.

The communication device 20 communicates with other vehicles around the vehicle M using, for example, a cellular network, a Wi-Fi network, Bluetooth (registered trademark), dedicated short range communication (DSRC), or the like or communicates with various server devices via wireless base stations.

The HMI 30 presents various types of information to occupants of the vehicle M and receives input operations by the occupants. For example, the HMI 30 includes various display devices, speakers, buzzers, touch panels, switches, and keys.

The suspension device 40 includes, for example, a mechanism that performs positioning axles, a mechanism that supports a vehicle weight and absorbs a shock from a road surface or the like to the vehicle M, and a mechanism that attenuates vibration occurring with the shock. The suspension device 40 is, for example, an air suspension that encloses a gas in a container such as a bag-like elastomer. The suspension device 40 may be a hydraulic suspension using oil or the like. An elastic body such as a spring may be combined with the suspension device 40. The suspension device 40 may be used to adjust minimum ground clearance of the vehicle M. The minimum ground clearance is, for example, a vertical distance from the ground surface of a horizontal road to the lowest portion of the vehicle body.

The suspension controller 42 controls a pneumatic pressure, a hydraulic pressure, or the like of the suspension device 40 based on a target trajectory generated by the action plan generator 123 to control the degree of buffering against a shock. The details of a function of the suspension controller 42 will be described later.

The navigation device 50 includes, for example, a global navigation satellite system (GNSS) receiver 51, a navigation HMI 52, and a route determiner 53 and retains first map information 54 in a storage device such as a hard disk drive (HDD) or a flash memory. The GNSS receiver 51 specifies a position of the vehicle M based on signals received from GNSS satellites. The position of the vehicle M may be specified or complemented by an inertial navigation system (INS) using an output of the vehicle sensor 70. The navigation HMI 52 includes a display device, a speaker, a touch panel, and a key. The navigation HMI 52 may be partially or entirely common to the above-described HMI 30. The route determiner 53 decides, for example, a route from a position of the vehicle M specified by the GNSS receiver 51 (or any input position) to a destination input by an occupant using the navigation HMI 52 with reference to the first map information 54. The first map information 54 is, for example, information in which a road shape is expressed by links indicating roads and nodes connected by the links. The first map information 54 may include curvatures of roads and point of interest (POI) information. The route decided by the route determiner 53 is output to the MPU 60. The navigation device 50 may perform route guidance using the navigation HMI 52 based on the route decided by the route determiner 53. The navigation device 50 may be realized by, for example, a function of a terminal device such as a smartphone or a tablet terminal possessed by a user. The navigation device 50 may transmit a current position and a destination to a navigation server via the communication device 20 to acquire a route replied from the navigation server.

The MPU 60 functions as, for example, a recommended lane determiner 61 and retains second map information 62 in a storage device such as an HDD or a flash memory. The recommended lane determiner 61 divides a route provided from the navigation device 50 into a plurality of blocks (for example, divides the route in a vehicle movement direction for each 100 [m]) and decides a recommended lane for each block with reference to the second map information 62. The recommended lane determiner 61 decides in which lane from the left the vehicle travels. When there is a branching location or a joining location in the route, the recommended lane determiner 61 decides a recommended lane so that the vehicle M can travel in a reasonable traveling route to move to a branching destination.

The second map information 62 is map information that has higher precision than the first map information 54. The second map information 62 includes, for example, information regarding the middles of lanes or information regarding boundaries of lanes. The second map information 62 may include road information, traffic regulation information, address information (address and postal number), facility information, and telephone number information. The road information includes information indicating kinds of roads such as expressways, toll roads, national ways, or prefecture roads and information such as the number of lanes of a road, an emergency parking area, the width of each lane, the gradients of roads, the positions of roads (3-dimensional coordinates including longitude, latitude, and height), curvatures of curves of lanes, positions of joining and branching points of lanes, and signs installed on roads. The second map information 62 may be updated frequently when the communication device 20 is used to access other devices.

The vehicle sensor 70 includes a vehicle speed sensor that detects a speed of the vehicle M, an acceleration sensor that detects acceleration, a yaw rate sensor that detects an angular velocity around a perpendicular axis, and an azimuth sensor that detects an orientation of the vehicle M. The vehicle sensor 70 includes a brake failure detection sensor that detects deterioration or the like of a brake actuator of the brake device 210 and a pneumatic sensor that detects whether a pneumatic pressure of a tire during traveling is equal to or less than a threshold.

The driving operator 80 includes, for example, an accelerator pedal, a brake pedal, a shift lever, a steering wheel, and other operators. A sensor that detects whether there is an operation or an operation amount is mounted on the driving operator 80 and a detection result is output to the automated driving controller 100, the travel driving power output device 200, or one or both of the brake device 210 and the steering device 220.

The vehicle interior camera 90 images the upper body of an occupant sitting on the driving seat centering on the face of the occupant. An image captured by the vehicle interior camera 90 is output to the automated driving controller 100.

### [Automated Driving Controller]

The automated driving controller 100 includes, for example, a first controller 120, a second controller 140, an interface controller 150, and a storage 160. Each of the first controller 120, the second controller 140, and the interface controller 150 is realized by causing a processor such as a central processing unit (CPU) to execute a program (software). Some or all of the constituent elements of the first controller 120, the second controller 140, and the interface controller 150 to be described below may be realized by hardware (a circuit unit including circuitry) such as a large scale integration (LSI), an application specific integrated circuit (ASIC), or a field-programmable gate array (FPGA), or may be realized by software and hardware in cooperation.

The first controller 120 includes, for example, an outside recognizer 121, an own vehicle position recognizer 122, and the action plan generator 123, and a passable determiner 124. One or both of the outside recognizer 121 and an obstacle recognizer 121A to be described below is an example of a “recognizer.”

The outside recognizer 121 recognizes states such as positions, speeds, or acceleration of surrounding vehicles based on information input from the camera 10, the radar device 12, and the finder 14 via the object recognition device 16. The positions of the surrounding vehicles may be represented as representative points such as centers, corners, or the like of the surrounding vehicles or may be represented as regions expressed by contours of the surrounding vehicles. The “states” of the surrounding vehicles may include acceleration or jerk of the surrounding vehicles or “action states” (for example, whether the surrounding vehicles are changing their lanes or are attempting to change their lanes). The outside recognizer 121 may recognize positions of a guardrail, an electricity pole, traffic signs, and other objects in addition to the surrounding vehicles.

The outside recognizer 121 includes, for example, an obstacle recognizer 121A and an estimator 121B. The obstacle recognizer 121A recognizes an obstacle in a moving direction of the vehicle M among surrounding objects recognized by the outside recognizer 121. The obstacle broadly means physical tangible objects and intangible objects that hinder traveling of the vehicle M. The obstacle is, for example, a fallen object that has fallen from a vehicle traveling in front or a fallen object that has fallen from a superstructure such as a tunnel or a bridge. The obstacle may be a vehicle that has stopped or has overturned on a road. The obstacle may be a construction site or the like on a road. The obstacle may be a pedestrian or an animal such as a cat or a dog having entered a road. The obstacle may be a natural phenomenon or a deterioration in a road such as a pool or a snowdrift on a road or a crack, hole, or a cave-in of a road or may be an object occurring in an accident or the like. The obstacle may be referred to as an “obstacle object” or an “obstacle event.” The details of a function of the obstacle recognizer 121A will be described later.

The estimator 121B estimates at least one of a kind and a shape of an obstacle recognized by the obstacle recognizer 121A. The details of a function of the estimator 121B will be described later.

The own vehicle position recognizer 122 recognizes, for example, a lane in which the vehicle M is traveling (an traveling lane) and a relative position and a posture of the vehicle M with respect to the traveling lane. The own vehicle position recognizer 122 recognizes, for example, the traveling lane by comparing patterns of road mark lines (for example, arrangement of continuous lines and broken lines) obtained from the second map information 62 with patterns of road mark lines around the vehicle M recognized from images captured by the camera 10. In this recognition, the position of the vehicle M acquired from navigation device 50 or a process result from INS may be added.

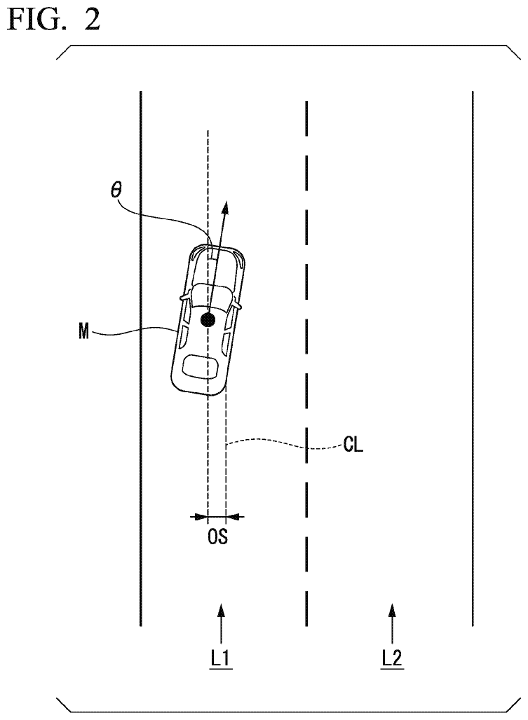

For example, the own vehicle position recognizer 122 recognizes a position or a posture of the vehicle M with respect to a traveling lane. FIG. 2 is a diagram illustrating an aspect in which the own vehicle position recognizer 122 recognizes a relative position and posture of a vehicle M with respect to a traveling lane L1. The own vehicle position recognizer 122 recognizes, for example, a deviation OS from a traveling lane center CL of a reference point (for example, a center of gravity) of the vehicle M and an angle θ formed with respect to a line drawn with the own lane center CL in the movement direction of the vehicle M as the relative position and the attitude of the own vehicle M with respect to the traveling lane L1. Instead of this, the own vehicle position recognizer 122 may recognize a position or the like of a reference point of the vehicle M with respect to either one side end of the traveling lane L1 as the relative position of the vehicle M with respect to the traveling lane. The relative position of the vehicle M recognized by the own vehicle position recognizer 122 is supplied to the recommended lane determiner 61 and the action plan generator 123.

The action plan generator 123 generates an action plan for performing automated driving of the vehicle M to a destination or the like. For example, the action plan generator 123 determines events sequentially performed in the automated driving so that the vehicle travels in a recommended lane determined by the recommended lane determiner 61 and a surrounding situation of the vehicle M can be handled. Examples of the events include a constant speed traveling event for traveling at a constant speed in the same traveling lane, a following traveling event for following a vehicle traveling in front, a lane changing event, a joining event, a branching event, an emergency stopping event, and a switching event for ending automated driving and switching to manual driving. An action for avoidance is planned based on a surrounding situation (presence of an obstacle, contraction of a lane due to road construction, or the like) of the vehicle M while such an event is being performed in some cases.

The action plan generator 123 generates a target trajectory along which the vehicle M travels in future. The target trajectory is expressed by arranging spots (trajectory points) at which the vehicle M arrives in sequence. The trajectory point is a spot at which the vehicle M arrives for each predetermined traveling distance. Apart from the trajectory points, a target speed and target acceleration are generated as parts of the target trajectory for each of predetermined sampling times (for example, about every several tenths of a second). The trajectory point may be a position at which the vehicle M arrives at the sampling time for each predetermined sampling time. In this case, information regarding the target speed or the target acceleration is expressed according to an interval between the trajectory points.

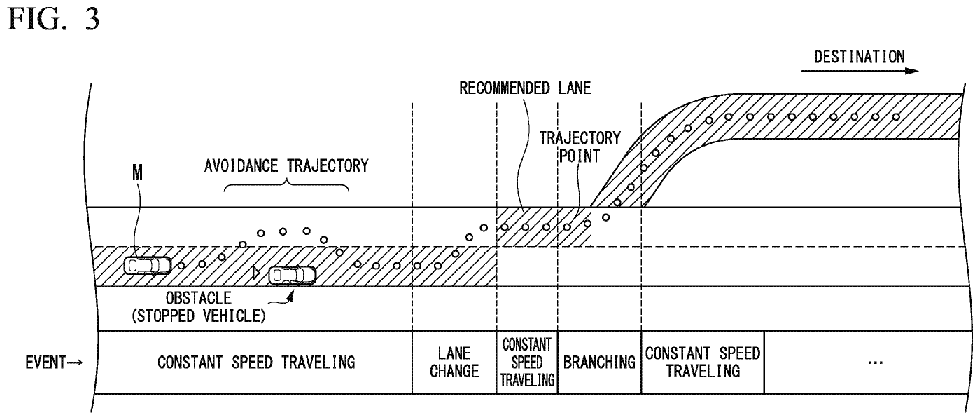

FIG. 3 is a diagram illustrating an aspect in which a target trajectory is generated based on a recommended lane. As illustrated, the recommended lane is set so that it is convenient to travel along a route to a destination. When the vehicle reaches a predetermined distance before a spot switching to the recommended lane (which may be decided in accordance with a type of event), the action plan generator 123 activates a lane changing event, a branching event, a joining event, or the like. When it is necessary to avoid an obstacle object during execution of each event, for example, a trajectory for avoidance may be generated, as illustrated.

For example, the action plan generator 123 generates a plurality of candidates for the target trajectory and selects an optimum target trajectory at that time based on the perspective of safety and efficiency.

For example, the action plan generator 123 changes an action plan of the vehicle M based on a determination result of the passable determiner 124 to be described below, for example. The details of the function will be described later.

The passable determiner 124 determines whether the vehicle can drive over an obstacle and pass by based on at least one of a kind or a shape of the obstacle object estimated by the estimator 121B. The details of a function of the passable determiner 124 will be described later.

The second controller 140 includes, for example, a traveling controller 141. The traveling controller 141 controls the travel driving power output device 200, the brake device 210, and the steering device 220 so that the vehicle M passes through the target trajectory generated by the action plan generator 123 at a scheduled time.

The interface controller 150 controls information output to the HMI 30. The interface controller 150 acquires information received by the HMI 30.

The storage 160 is a storage device such as a hard disk drive (HDD), a flash memory, a random access memory (RAM), or a read-only memory (ROM). The storage 160 stores, for example, an estimation table 160A and setting information 160B. The details of the estimation table 160A and the setting information 160B will be described later.

The travel driving power output device 200 outputs travel driving power (torque) for traveling the vehicle to a driving wheel. The travel driving power output device 200 includes, for example, a combination of an internal combustion engine, an electric motor and a transmission, and an ECU controlling these units. The ECU controls the foregoing constituents in accordance with information input from the traveling controller 141 or information input from the driving operator 80.

The brake device 210 includes, for example, a brake caliper, a cylinder that transmits a hydraulic pressure to the brake caliper, an electronic motor that generates a hydraulic pressure in the cylinder, and a brake ECU. The brake ECU controls the electric motor in accordance with information input from the traveling controller 141 such that a brake torque in accordance with a brake operation is output to each wheel. The brake device 210 may include a mechanism that transmits a hydraulic pressure generated in response to an operation of the brake pedal included in the driving operator 80 to the cylinder via a master cylinder as a backup. The brake device 210 is not limited to the above-described configuration and may be an electronic control type hydraulic brake device that controls an actuator in accordance with information input from the traveling controller 141 such that a hydraulic pressure of the master cylinder is transmitted to the cylinder. The brake device 210 may include a plurality of systems of brake devices in consideration of safety.

The steering device 220 includes, for example, a steering ECU and an electric motor. The electric motor applies a force to, for example, a rack and pinion mechanism to change a direction of a steering wheel. The steering ECU drives the electric motor to change the direction of the steering wheel in accordance with information input from the traveling controller 141 or information input from the driving operator 80.

[Automated Driving Control in Accordance with Obstacle]

Hereinafter automated driving control in accordance with an obstacle will be described. The vehicle M according to an embodiment determines whether there is an obstacle on a traveling route in automated driving based on the action plan generated by the action plan generator 123 and changes the action plan based on at least one of a kind and a shape of an obstacle when there is an obstacle.

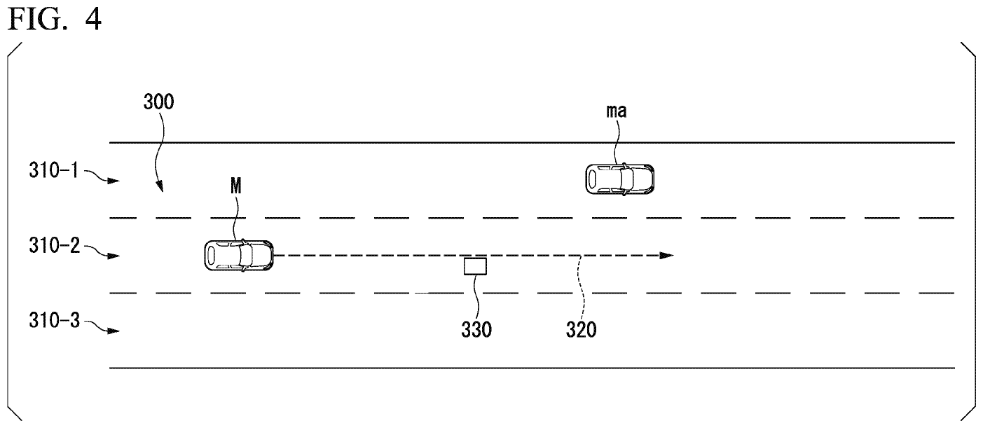

FIG. 4 is a diagram illustrating an aspect of an obstacle object in front of the vehicle M. In a road 300 illustrated in FIG. 4, there are three lanes 310-1 to 310-3. The action plan generator 123 causes the vehicle M to travel along a target trajectory 320 generated based on the traveling route to the destination through automated driving.

Here, the outside recognizer 121 detects objects around the vehicle M. The obstacle recognizer 121A recognizes, for example, an object which is on the lane 310-2 of the target trajectory 320 in a moving direction of the vehicle M among the detected objects as an obstacle object 330. The obstacle recognizer 121A may recognize the object as the obstacle object 330 when the size of the object which is in the moving direction is equal to or greater than a predetermined size.

The estimator 121B estimates at least one of a kind and a shape of the obstacle object based on feature amounts obtained during a recognition course of the obstacle object 330 recognized by the obstacle recognizer 121A. The feature amounts of the obstacle object 330 are, for example, feature amounts extracted based on information input from the camera 10, the radar device 12, and the finder 14 via the object recognition device 16. For example, the feature amounts include at least one of feature amounts obtained from all the images captured by the camera 10, feature amounts obtained from an edge or edge pattern of the obstacle object 330, feature amounts obtained from light and shade, color, and a color histogram of the obstacle object 330, and feature amounts obtained from the shape and size of the obstacle object 330. The feature amount may be a feature amount associated with a position or a speed of the object obtained from the radar device 12. The feature amount may be a feature amount associated with the position of the object obtained from the finder 14.

The estimator 121B extracts a feature amount of the obstacle object 330 using all or some of the feature amounts. The estimator 121B estimates a kind or a shape of the obstacle object 330 with regard to the extracted feature amounts. For example, the estimator 121B acquires information regarding at least one of the kind and the shape of the obstacle object 330 corresponding to the feature amount with reference to the estimation table 160A stored in the storage 160 based on the extracted feature amounts.

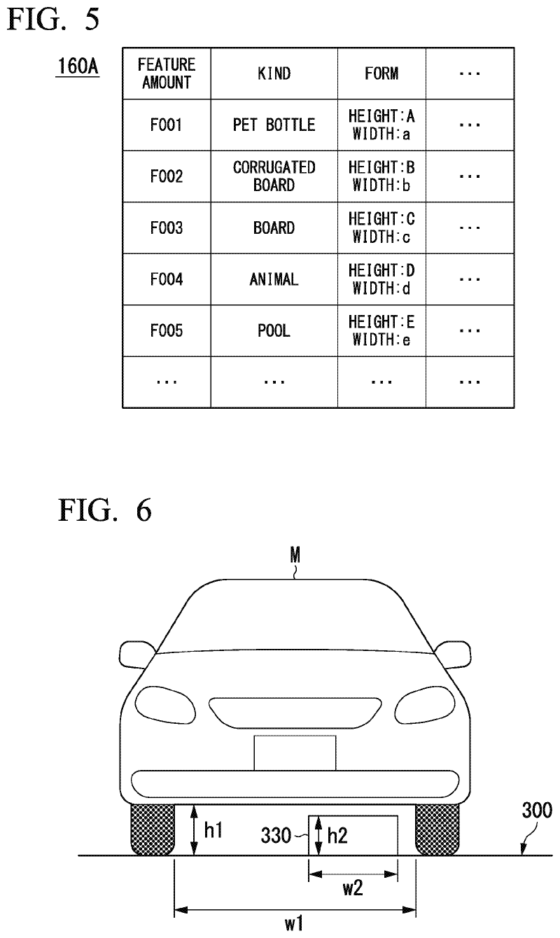

FIG. 5 is a diagram illustrating an example of an estimation table 160A. The estimation table 160A is, for example, information in which the kind and the shape are associated with the feature amounts. The kind is information for specifying a kind of object. The shape is, for example, the height and width of the obstacle object 330 when the obstacle object 330 is seen in the moving direction of the vehicle M.

The passable determiner 124 determines whether the vehicle M can drive over and pass by the obstacle object 330 based on at least one of the kind and the shape of the obstacle object 330 estimated by the estimator 121B and the information regarding the shape of the vehicle M. The information regarding the shape of the vehicle M is, for example, at least one of the vehicle width of the vehicle M, the minimum ground clearance, the width between the left and right wheels of the vehicle M, the sizes of the wheels, and the size of the vehicle body. The information regarding the shape of the vehicle M is stored in, for example, the storage 160.

FIG. 6 is a diagram illustrating an aspect of passable determination. In the example of FIG. 6, the vehicle M traveling on the road 300 and the obstacle object 330 on the traveling route of the vehicle M are indicated. The passable determiner 124 compares a width w1 and a minimum ground clearance h1 between the left and right wheels of the vehicle M stored in advance in the storage 160 with a width w2 and a height h2 of an obstacle object estimated by the estimator 121B.

For example, when the minimum ground clearance h1 of the vehicle M is higher than the height h2 of the obstacle object 330 and the width w1 between the left and right wheels is longer than the width w2 of the obstacle object 330, the passable determiner 124 determines that the vehicle M can drive over and pass by the obstacle object 330. Conversely, when the minimum ground clearance h1 of the vehicle M is higher than the height h2 of the obstacle object 330 and the width w1 between the left and right wheels is equal to or less than the width w2 of the obstacle object 330, the passable determiner 124 determines whether the vehicle M can drive over and pass by the obstacle object 330 based on the kind of obstacle object 330.

The passable determiner 124 may determine that the vehicle can drive over and pass by the obstacle object 330 when the obstacle object 330 is a soft thing such as a PET bottle based on the kind of the obstacle object 330 estimated by the estimator 121B.

When the kind of obstacle object 330 is a card-board, the passable determiner 124 may determine whether content of the card-board is empty. The emptying out of the content also includes a case in which a hollow portion is included inside the obstacle object 330. In this case, the passable determiner 124 determines whether the content of the obstacle object 330 is empty from information obtained by radiating X rays or the like to the obstacle object 330 from the radar device 12. The passable determiner 124 may extract the degree of deformation of the obstacle object 330 from a predetermined shape stored in the estimation table 160A and the actual shape of the obstacle object 330 acquired from an image captured by the camera 10 and may determine that the content of the obstacle object 330 is empty when the extracted degree of deformation is equal to or greater than a threshold. When the passable determiner 124 determines that the content of the obstacle object 330 is empty, the passable determiner 124 may determine that the vehicle can drive over and pass by the obstacle object 330. Thus, for example, even when the height h2 of the obstacle object 330 is higher than the minimum ground clearance h1 of the vehicle M, the vehicle can drive over and pass by.

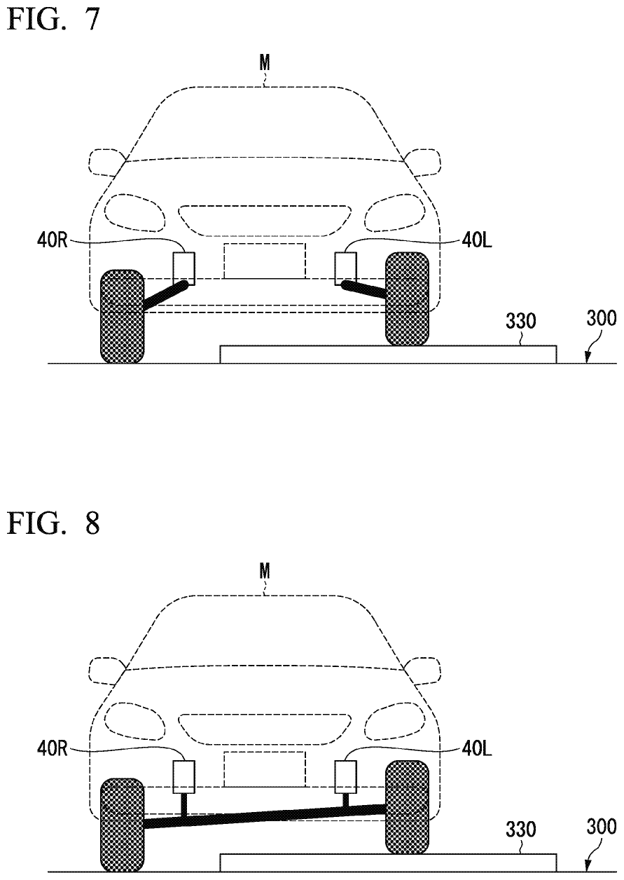

FIG. 7 is a diagram illustrating an aspect in which the vehicle M drives over the obstacle object 330 to travel. In the example of FIG. 7, the obstacle object 330 is illustrated as a board. In the example of FIG. 7, an independent suspension type in which the left and right wheels of the vehicle M operate independently is schematically illustrated. The vehicle M includes suspension devices 40L and 40R corresponding to the left and right wheels. The suspension devices 40L and 40R are controlled by the suspension controller 42. By using the independent suspension type, even a case of movement of one of the left and right wheels does not affect the other wheel. Therefore, it is possible to improve performance of each of the left and right suspensions.

In the embodiment, an axle suspension type may be used instead of the independent suspension type. FIG. 8 is a diagram illustrating an axle suspension type. The axle suspension type illustrated in FIG. 8 has a simpler structure and can be manufactured at lower cost than the independent suspension type. In this case, the left and right suspension devices 40L and 40R are controlled by the suspension controller 42.

When the passable determiner 124 determines that the vehicle M can drive over and pass by the obstacle object 330, the suspension controller 42 controls the degree of buffering by the suspension devices 40L and 40R immediately before the vehicle M drives over the obstacle object 330 (for example, a distance from the obstacle object 330 is less than a predetermined distance) or while the vehicle M is driving over the obstacle object 330. For example, immediately before the vehicle M drives over the obstacle object 330 or while the vehicle M is driving over the obstacle object 330, the suspension controller 42 controls pneumatic pressures or hydraulic pressures of the suspension devices 40 corresponding to the wheels driving over the obstacle object 330 to raise the degree of buffering.

In the examples of FIGS. 7 and 8, only the left wheel of the vehicle M drives over the obstacle object 330. Accordingly, the suspension controller 42 controls the pneumatic pressure or hydraulic pressure of the suspension device 40L corresponding to the left wheel. Thus, it is possible to suppress vibration occurring and keep the vehicle body horizontal when the vehicle M drives over the obstacle object 330. When the vehicle drives over with all the left and right wheels of the obstacle object 330, the suspension controller 42 may raise the degree of buffering of the left and right suspension devices 40L and 40R. The suspension controller 42 may control the degree of buffering of each of the suspension devices 40L and 40R differently in accordance with the shape or the like of the obstacle object 330.

When the vehicle M drives over and passes by the obstacle object 330, the action plan generator 123 may perform control related to an accelerated or decelerated speed of the vehicle M in accordance with the action plan. In this case, for example, the action plan generator 123 performs deceleration control from a predetermined distance before the vehicle M drives over the obstacle object. Thus, it is possible to alleviate a shock when the vehicle M drives over the obstacle object 330 or minimize slipping or the like in a state in which the vehicle M drives on the obstacle object 330. The action plan generator 123 may perform acceleration control up to the original speed after the vehicle M drives over the obstacle object 330.

The action plan generator 123 may perform acceleration control until a speed of the vehicle M is equal to or greater than a predetermined speed when the speed of the vehicle M is equal to or less than a threshold. Thus, it is possible to easily drive over the obstacle object 330.

When the vehicle M drives over the obstacle object 330 to travel, the action plan generator 123 may perform control related to steering of the vehicle M in accordance with the action plan. In this case, the action plan generator 123 performs control such that steering is fixed, for example, in a state in which the vehicle drives over the obstacle object. Thus, it is possible to curb a phenomenon in which the obstacle object 330 flies due to being slipped by a wheel or the vehicle M slips errant due to steering control in a state in which the vehicle M drives on the obstacle object 330.

The interface controller 150 may control sound to be output from a speaker of the HMI 30 in a state in which the vehicle M drives over the obstacle object 330. For example, in a state in which the vehicle M drives over the obstacle object 330, the interface controller 150 can output a sound from the speaker so that an occupant may not hear a sound produced when the vehicle M drives the obstacle object 330. The interface controller 150 may output a sound set for each kind of obstacle object 330 from the speaker. Thus, an occupant can specify the kind of obstacle object 330 even when the occupant does not see the obstacle object 330.

For example, when the kind of obstacle object 330 is a sharp thing or an animal or when the height h2 of the obstacle object 330 is higher than the minimum ground clearance h1 of the vehicle M, the passable determiner 124 determines that the vehicle M may not drive over and pass by the obstacle object 330. In this case, the action plan generator 123 generates an action plan to avoid the obstacle object 330 for traveling. The avoidance traveling includes a case in which the vehicle M drives over the obstacle object 330 to travel, a case in which the vehicle M avoids the obstacle object 330 to travel within the same lane as a traveling lane, and a case in which the lane is changed to avoid the obstacle object 330 to travel.

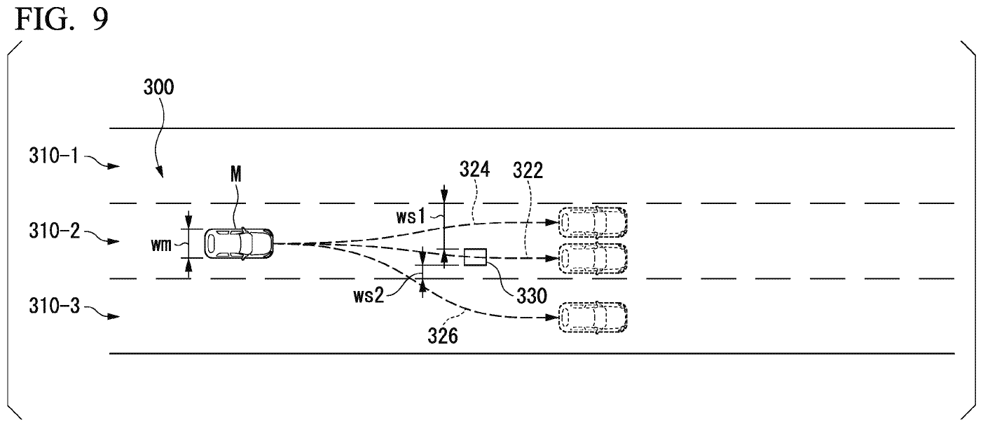

FIG. 9 is a diagram illustrating an aspect in which an obstacle object is avoided for traveling. For example, when the minimum ground clearance h1 of the vehicle M is higher than the height h2 of the obstacle object 330 and the width w1 between the left and right wheels is longer than the width w2 of the obstacle object 330, the passable determiner 124 determines that the vehicle M can drive over and pass by the obstacle object 330. In this case, as illustrated in FIG. 9, the action plan generator 123 generates a target trajectory 322 so that the obstacle object 330 passes between the left and right wheels and travels the vehicle M along the generated target trajectory 322.

When the height h2 of the obstacle object 330 is higher than the minimum ground clearance h1 of the vehicle M, the action plan generator 123 compares a vehicle width wm illustrated in FIG. 9 with a longer empty width between empty widths ws from both ends of the obstacle object 330 to the end of a demarcation line demarcating the lane 310. In the example of FIG. 9, an empty width ws1 is longer than an empty width ws2. Accordingly, the action plan generator 123 compares the vehicle width wm with the empty width ws1. When the vehicle width wm is less than the empty width ws1, the action plan generator 123 may determine that the vehicle can avoid the obstacle object within the same lane as the lane 310-2 in which the vehicle is traveling, generate a target trajectory 324 to avoid the obstacle object 330 and travel in the same lane, travel the vehicle M along the generated target trajectory 324.

When the vehicle width wm is greater than the distance ws1, the action plan generator 123 may generate a target trajectory 326 to change the lane to the lane 310-3 adjacent to the lane 310-2 in which the vehicle M is traveling and travel the vehicle M along the generated target trajectory 326, as illustrated in FIG. 9.

When the height h2 of the obstacle object 330 is higher than the minimum ground clearance h1 of the vehicle M, the action plan generator 123 may cause the suspension controller 42 to control the suspension devices 40 such that the minimum ground clearance h1 of the vehicle M is higher than the height h2 of the obstacle object 330. Thus, the action plan generator 123 can travel the vehicle M along the target trajectory 322 in which the vehicle M drives over the obstacle object 330 without considerable movement such as a change in the lane.

When the kind of obstacle object 330 is an animal, the action plan generator 123 may perform control such that the interface controller 150 outputs a sound such as klaxon to allow the animal to escape.

In this way, in the embodiment, when there is the obstacle object 330, it is possible to realize traveling through appropriate automated driving in accordance with the obstacle object by changing the action plane based on the kind or the shape of the obstacle object 330. Accordingly, it is possible to suppress congestion due to an inappropriate change in a lane or the like.

In the embodiment, when the automated driving is performed in accordance with the above-described obstacle object 330, the action plan generator 123 may generate an action plan based on the setting information 160B set by an occupant. In this case, when content set by the occupant is setting for traveling route priority with reference to the setting information 160B stored in the storage 160, the passable determiner 124 determines whether the vehicle can drive over and pass by based on at least one of the kind and the shape of the obstacle object 330 described above. When the content set by an occupant is setting for obstacle object avoidance priority with reference to the setting information 160B, the passable determiner 124 generates an action plan to avoid and pass by the obstacle object 330 irrespective of the kind or the shape of the obstacle object 330 described above.

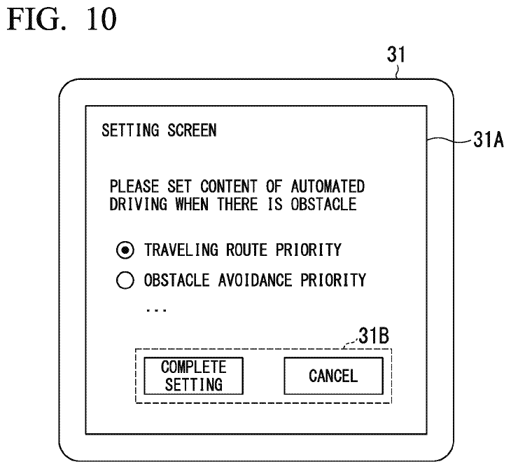

The interface controller 150 may display a setting screen on a display device or the like of the HMI 30 and receives a setting registration, change, or the like of the setting information 160B by an occupant. FIG. 10 is a diagram illustrating an example of a setting screen on which content of the automated driving is set. In the example of FIG. 10 a setting screen 31A is displayed on the display device 31 of the HMI 30. The setting screen 31A includes a button selection region 31B. Before the vehicle M starts traveling, before the automated driving starts, or at a predetermined timing at which a predetermined operation by an occupant is received, the interface controller 150 displays the setting screen 31A on the display device 31. On the setting screen 31A, selection items for priority of a lane in which the vehicle is traveling, priority of priority of avoidance of the obstacle object 330, and the like are displayed. On the setting screen 31A, a radio button for selecting any of the plurality of selection items is displayed.

When a user's selection of a graphical user interface (GUI) switch of “Complete setting” displayed in the button selection region 31B is received, the action plan generator 123 generates an action plan based on the setting information set at that time point. For example, when “traveling route priority” illustrated in FIG. 10 is set, the action plan generator 123 generates an action plan to drive over and pass by the obstacle object 330 and performs automated driving based on the generated action plan. When “obstacle object avoidance priority” illustrated in FIG. 10 is set, the action plan generator 123 generates an action plan to avoid the obstacle object 330 to travel without driving over the obstacle object 330 and performs automated driving based on the generated action plan. Thus, for example, it is possible to realize automated driving in accordance with an intention of an occupant, for example, when the occupant is anxious about uncleanness or the like of the vehicle M and does not want to drive over an obstacle object.

### [Process Flow]

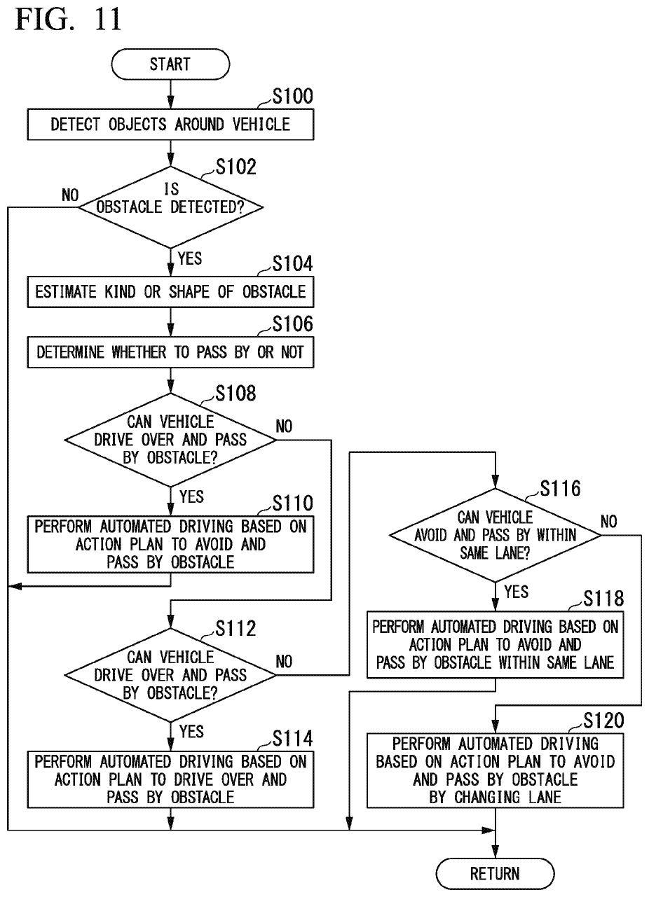

Hereinafter, an example of various kinds of vehicle control by the vehicle system 1 according to the embodiment will be described. FIG. 11 is a flowchart illustrating an example of action plan generation according to an embodiment. A process of FIG. 11 is repeatedly performed during automated driving. The process of FIG. 11 is a process of changing an action plan under a predetermined condition in a state in which the action plan is generated based on a destination value set in advance and the automated driving is performed in accordance with the generated action plan.

First, the outside recognizer 121 detects objects around the vehicle M (step S100). Subsequently, the obstacle recognizer 121A determines whether there is an obstacle object among the detected objects (step S102). When the obstacle object is recognized, the estimator 121B estimates a kind or a shape of the obstacle object (step S104).

Subsequently, the passable determiner 124 performs passable determination on the obstacle object of the vehicle M based on the estimated kind or shape of the obstacle object and information regarding the shape of the vehicle M (step S106). The passable determiner 124 determines whether the vehicle can drive over and pass by the obstacle object (step S108). When the vehicle can drive over and pass by the obstacle object, the action plan generator 123 performs the automated driving based on an action plan to drive over and pass by the obstacle object (step S110).

When the vehicle may not drive over and pass by the obstacle object, the action plan generator 123 generates an action plan to avoid and pass by the obstacle object. In this case, the passable determiner 124 determines whether the vehicle can drive over and pass by the obstacle object (step S112). When the vehicle can drive over and pass by the obstacle object, the action plan generator 123 performs the automated driving based on the action plan to drive over and pass by the obstacle object (step S114).

When the vehicle may not drive over and pass by the obstacle object, the passable determiner 124 determines whether the vehicle avoids and passes by the obstacle object within the same lane (step S116). When the vehicle can avoid and pass by within the same lane, the action plan generator 123 performs the automated driving based on an action plan to avoid and pass by the obstacle object within the same lane (step S118). Conversely, when the vehicle may not avoid and pass by within the same lane, the action plan generator 123 performs the automated driving based on an action plan to avoid and pass by the obstacle object by changing the lane (step S120). Thus, the process of the flow chart ends. Even when the obstacle object may not be recognized among the detected objects in step S102, the process of the flowchart ends.

According to the vehicle control system, the server device, the vehicle control method, and the vehicle control program according to the above-described embodiments, it is possible to realize traveling through appropriate automated driving in accordance with a kind or a shape of an obstacle. According to the embodiment, by controlling the suspension device, it is possible to alleviate a shock or slipping by the obstacle or it is possible to minimize slipping due to the obstacle when the vehicle drives over an obstacle. According to the embodiment, since a lane is not changed against all the obstacles, it is possible to realize driving through appropriate automated driving. According to the embodiment, it is possible to suppress congestion or the like due to an inappropriate lane change. According to the embodiment, it is possible to realize automated driving in accordance with an intention of an occupant, for example, when the occupant is anxious about uncleanness or the like of the vehicle and does not want to drive over an obstacle object.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### REFERENCE SIGNS LIST

1 Vehicle system
10 Camera
12 Radar device
14 Finder
16 Object recognition device
20 Communication device
30 HMI
40 Suspension device
42 Suspension controller
50 Navigation device
60 MPU
70 Vehicle sensor
80 Driving operator
90 Vehicle interior camera
100 Automated driving controller
120 First controller
121 Outside recognizer
121A Obstacle recognizer
121B Estimator
122 Own vehicle position recognizer
123 Action plan generator
124 Passable determiner
140 Second controller
141 Traveling controller
150 Interface controller
160 Storage
M Vehicle

What is claim is:

1. A vehicle control system comprising:
a recognizer configured to recognize an obstacle in a moving direction of a vehicle;
an estimator configured to estimate at least one of a kind and a shape of the obstacle recognized by the recognizer; and
an action plan generator configured to generate an action plan of the vehicle based on an estimation result of the estimator.

2. The vehicle control system according to claim 1, wherein the estimator estimates at least one of the kind and the shape of the obstacle based on a feature amount obtained in a recognition course by the recognizer.

3. The vehicle control system according to claim 1, wherein the action plan generator generates an action plan to drive over or avoid the obstacle based on the estimation result of the estimator.

4. The vehicle control system according to claim 3, wherein the action plan generator decelerates the vehicle when the action plan to drive over the obstacle is generated.

5. The vehicle control system according to claim 1, further comprising:
a passable determiner configured to determine whether the vehicle drives over and passes by the obstacle based on at least one of the kind and the shape of the obstacle estimated by the estimator and information regarding a shape of the vehicle.

6. The vehicle control system according to claim 1, wherein the action plan generator generates an action plan to perform at least one of a change in a state of the vehicle and control related to steering of the vehicle when the vehicle drives over the obstacle.

7. The vehicle control system according to claim 1, further comprising:
a buffering device configured to alleviate a shock from a road surface to the vehicle; and
a buffering degree controller configured to control the degree of buffering by the buffering device before the vehicle drives over the obstacle or while the vehicle drives over the obstacle.

8. The vehicle control system according to claim 1, further comprising:
a receptor configured to receive an operation from an occupant of the vehicle,
wherein, on the basis of setting information which is based on the operation received by the receptor, the action plan generator changes the action plan which is based on the obstacle.

9. The vehicle control system according to claim 5, wherein the passable determiner determines that the vehicle drives over and passes by the obstacle based on the degree of deformation from a predetermined shape of the obstacle.

10. A vehicle control method comprising: by an onboard computer,
recognizing an obstacle in a moving direction of a vehicle;
estimating at least one of a kind and a shape of the recognized obstacle; and
generating an action plan of the vehicle based on an estimated result.

11. A non-transitory computer-readable storage medium that stores a vehicle control program to be executed by a vehicle computer to perform at least:
recognizing an obstacle in a moving direction of a vehicle;
estimating at least one of a kind and a shape of the recognized obstacle; and
generating an action plan of the vehicle based on an estimated result.
